(19) United States
(12) Patent Application Publication
(10) Pub. No.: US 2019/0205841 A1
(43) Pub. Date: Jul. 4, 2019

(54) TIME IMPACT INDICATION SYSTEM

(71) Applicant: Microsoft Technology Licensing, LLC, Redmond, WA (US)

(72) Inventors: Eva B. K. Burlin, Redmond, WA (US); Eric Scott Courtemanche, Seattle, WA (US); Haebin Seo, Seattle, WA (US); Ian Dwyer Curry, Seattle, WA (US); Teslim Abiodun Alabi, Redmond, WA (US); Paul D. Tischhauser, Redmond, WA (US); Phoebe Eyonnie Ash, Renton, WA (US); Shahil Soni, Seattle, WA (US); SungJae Park, Redmond, WA (US); Daniel Sungje Choi, Redmond, WA (US); Sara Wiltberger, Redmond, WA (US); Skye Pazuchanics, Redmond, WA (US)

(21) Appl. No.: 15/858,809

(22) Filed: Dec. 29, 2017

(51) Int. Cl. G06Q 10/10; G06F 17/30; G06N 99/00

(52) U.S. Cl. CPC G06Q 10/1097; G06N 99/005; G06F 17/30342

(57) ABSTRACT

A scheduling system suitable for tracking and visually indicating impact of events on free time is provided. The scheduling system receives a request associated with an event. In response, the scheduling system accesses, from a data storage, user data structure for a user associated with the event, whereby the user data structure indicates scheduling information for the user including free time of the user. The scheduling system determines an impact on the free time of the user based on the user attending the event. The scheduling system then generates a user interface that includes a visual indication of the impact of attending the event on the free time of the user and causes presentation of the user interface on a client device of the user.

### TECHNICAL FIELD

The subject matter disclosed herein generally relates to special-purpose machines that facilitate tracking event scheduling and visually presenting an impact events have on time, including computerized variants of such special-purpose machines and improvements to such variants, and to the technologies by which such special-purpose machines become improved compared to other special-purpose machines that track event scheduling and present timing information. Specifically, the present disclosure addresses systems and methods that track events or invitations to events, determine an impact on time based on those events, and visually present the impact in specially configured user interfaces.

### BACKGROUND

Conventionally, an impact of an event on time is not fully understood by a computing system or its user. When the computing system creates or receives an invitation for an event, conventionally, the computing system simply provides an option to accept or reject the invitation. However, the impact of accepting the invitation is not known or visually presented by the computing system such that an informed decision can be made.

### BRIEF DESCRIPTION OF THE DRAWINGS

Some embodiments are illustrated by way of example and not limitation in the figures of the accompanying drawings.

FIG. 1 is a block diagram illustrating an example environment for tracking event scheduling and visually presenting an impact events have on time in accordance with an example embodiment.

FIG. 2 is a block diagram illustrating components within a scheduling system in accordance with an example embodiment.

FIG. 3 is a flow diagram of an example method for creating an event invitation that includes a visual indication of an impact on time.

FIG. 4 illustrates an example event creation user interface that includes a visual indication of an impact on time.

FIG. 5 is a flow diagram of an example method for managing a response process to the event invitation.

FIG. 6 illustrates an example event invitation user interface that includes a visual indication of an impact on time.

FIG. 7 is a diagrammatic representation of a machine in an example form of a computing system within which a set of instructions may be executed for causing the machine to perform any one or more of the methodologies discussed herein, according to an example embodiment.

### DETAILED DESCRIPTION

The description that follows describes systems, methods, techniques, instruction sequences, and computing machine program products that illustrate example embodiments of the present subject matter. In the following description, for purposes of explanation, numerous specific details are set forth in order to provide an understanding of various embodiments of the present subject matter. It will be evident, however, to those skilled in the art, that embodiments of the present subject matter may be practiced without some or other of these specific details. Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided.

Example methods (e.g., algorithms) and systems (e.g., special-purpose machines) facilitate tracking events or event invitations, determining an impact on time based on those events, and visually presenting the impact in specially configured user interfaces. An event may be any activity for which the user wants to explicitly set aside time on a computing system managed calendar such as, for example, a meeting or conference call. In particular, example embodiments provide mechanisms and logic that determine, based on existing events on a computing system managed calendar, an impact a new event presented in an event creation or invitation user interface will have on free time of a user if the event is created or accepted and added to the computing system managed calendar. Free time may, in one embodiment, be the time on the computing system managed calendar that is not explicitly blocked off on the computing system managed calendar for an event (e.g., any unblocked off time during working hours). Free time is time that is inherently reserved for focusing on work or personal matters that are not associated with an event. Thus, the free time may be, or may include, focus time, whereby focus time is time set aside to focus on tasks (e.g., work) that should or need to be performed during the day.

In accordance with example embodiments, a scheduling system suitable for tracking and visually indicating an impact on free time based events is provided. The scheduling system receives a request associated with an event. In response, the scheduling system accesses, from a data storage, user data structure for a user associated with the event, whereby the user data structure indicates scheduling information for the user including free time inherently set aside or reserved (e.g., unblocked time on a computing system managed calendar) for the user. The scheduling system determines an impact on the free time of the user if the user attends the event. The scheduling system then generates a specially configured user interface that includes a visual indication of the impact on the free time of the user based on attending the event and causes presentation of the specially configured user interface on a client device of the user.

As a result, one or more of the methodologies described herein facilitate solving the technical problem of tracking and visually presenting impact on free time based on an event that is scheduled or for which a user is invited to attend. As such, one or more of the methodologies described herein may obviate a need for certain efforts or computing resources that otherwise would be involved in manually determining the impact on time or rearranging of schedules based on lack of understanding of the impact on free time in response to attendance of one or more events. As a result, resources used by one or more machines, databases, or devices (e.g., within the environment) may be reduced. Examples of such computing resources include processor cycles, network traffic, memory usage, data storage capacity, power consumption, network bandwidth, and cooling capacity.

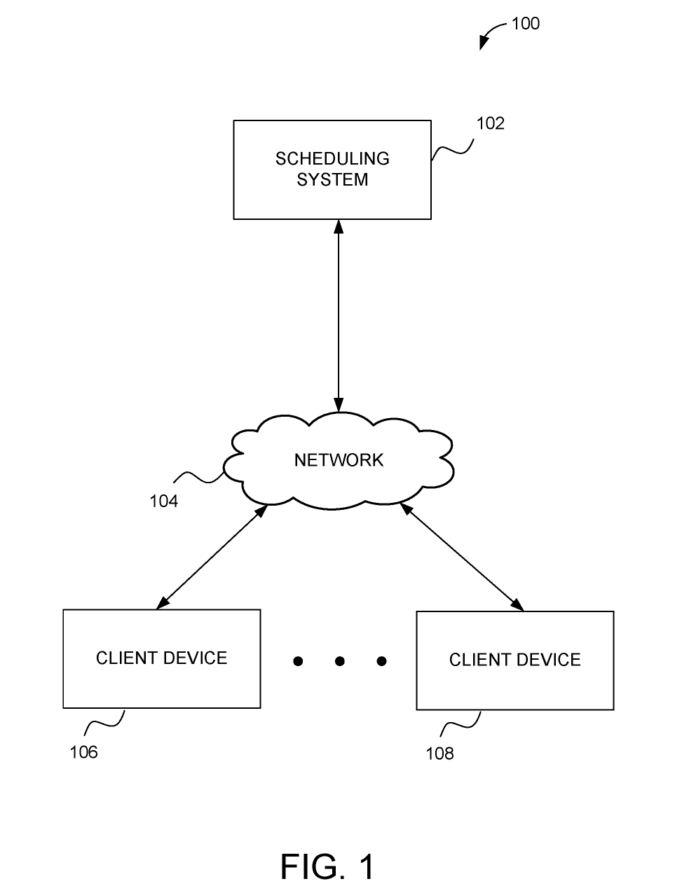

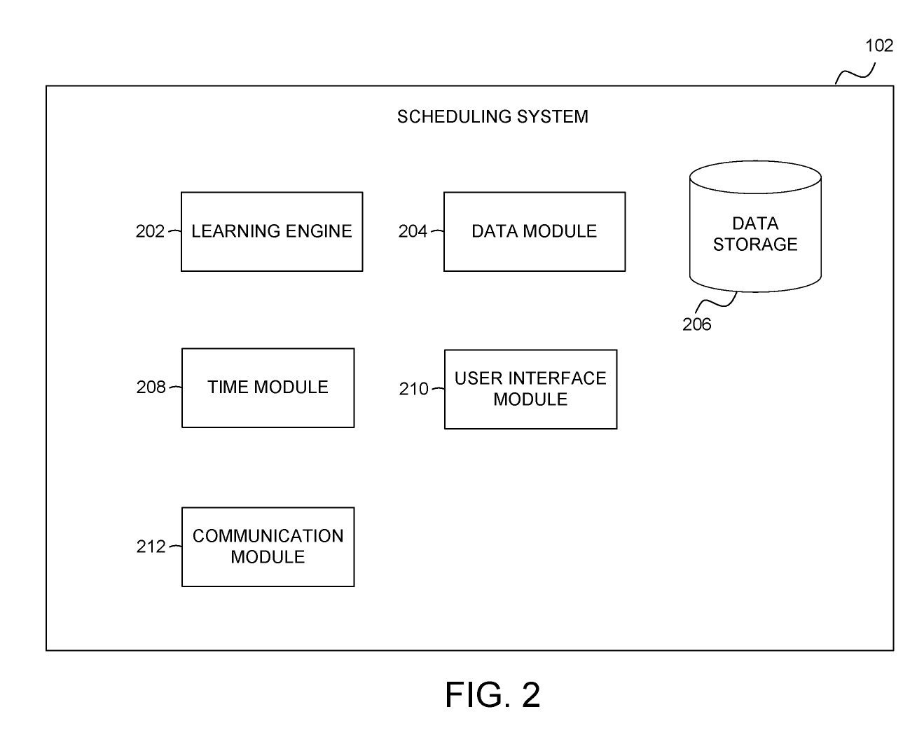

FIG. 1 is a block diagram illustrating an example environment 100 for determining impact on free time based on events and visually presenting the impact in specially configured user interfaces. In example embodiments, a scheduling system 102 comprises one or more servers configured to manage events including creating invitations to a new event, tracking event scheduling and impact of the new event on free time of a user, and visually presenting the impact of the new event in specially configured user interfaces. The scheduling system 102 will be discussed in more detail in connection with FIG. 2 below.

The scheduling system 102 is coupled, via a network 104, to one or more client devices (e.g., client device 106 and client device 108). One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a Wi-Fi network, a WiMax network, a satellite network, a cable network, a broadcast network, another type of network, or a combination of two or more such networks. Any one or more portions of the network 104 may communicate information via a transmission or signal medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

The client devices 106 and 108 are devices of users that may work together or otherwise may be involved in an event (e.g., a meeting). For example, the user at the client device 106 may, via a specially configured user interface, create an event and a corresponding event invitation via the scheduling system 102. The event invitation invites the user of the client device 108 to attend the event. As such, the user at the client device 108 receives the event invitation via another specially configured user interface generated and transmitted from the scheduling system 102. In the specially configured user interfaces, an impact of attending the event on each user's free time is indicated. In some embodiments, the client devices 106 and 108 make service calls to the scheduling system 102 to cause the presentation of the user interfaces (e.g., obtain the data to display the user interfaces). In alternative embodiments, some of the functions of the scheduling system 102 (discussed below) may be performed at the client devices 106 and 108.

The client devices 106 and 108 may comprise, but are not limited to, a smartphone, tablet, laptop, multi-processor system, microprocessor-based or programmable consumer electronics, game console, set-top box, or any other device that a user utilizes to communicate over the network 104. In example embodiments, the client devices 106 and 108 comprise a display module (not shown) to display information (e.g., in the form of specially configured user interfaces). In some embodiments, the client devices 106 and 108 may comprise one or more of a touch screen, camera, keyboard, microphone, and Global Positioning System (GPS) device.

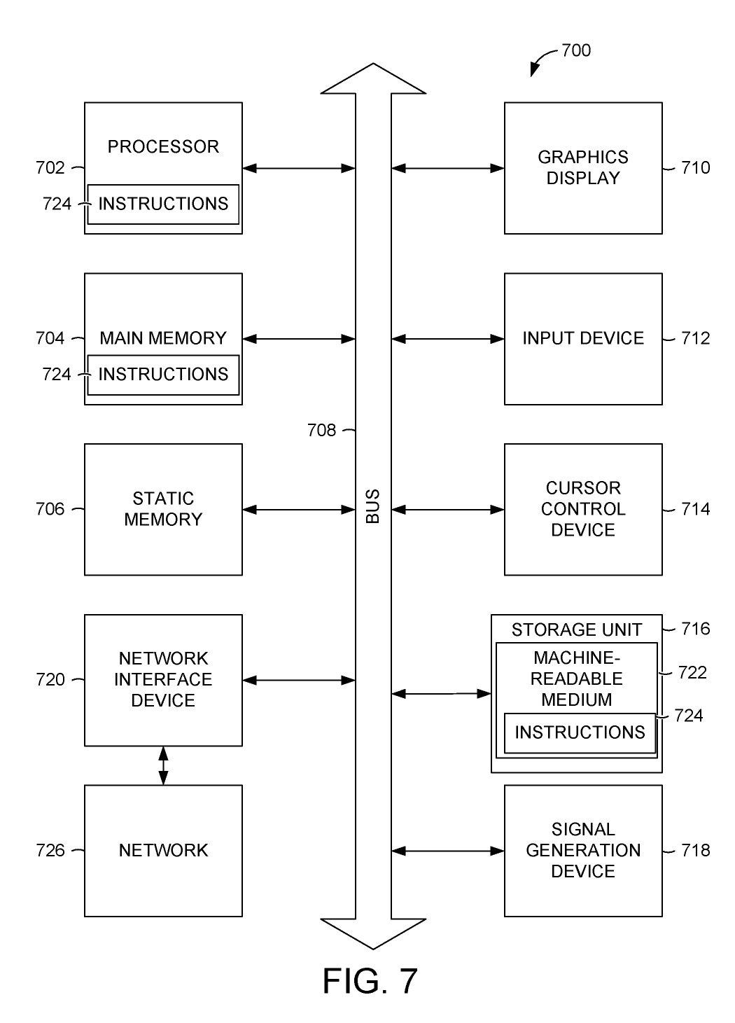

Any of the systems or machines (e.g., databases, devices, servers) shown in, or associated with, FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIG. 7, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the systems or machines illustrated in FIG. 1 may be combined into a single system or machine, and the functions described herein for any single system or machine may be subdivided among multiple systems or machines. Additionally, any number and types of client devices 106 and 108 may be embodied within the environment 100. Furthermore, some components or functions of the environment 100 may be combined or located elsewhere in the environment 100. For example, some of the functions of the scheduling system 102 may be embodied within the client device 106 or 108.

FIG. 2 is a block diagram illustrating an example embodiment of components within the scheduling system 102. In example embodiments, the scheduling system 102 performs operations to manage events including creating invitations to a new event, tracking event scheduling and impact of the new event on free time of a user, and visually presenting the impact of the new event in specially configured user interfaces. To enable these operations, the scheduling system 102 comprises a learning engine 202, a data module 204, a data storage 206, a time module 208, a user interface module 210, and a communication module 212 all of which are configured to communicate with each other (e.g., over a bus, shared memory, or a switch) in accordance with an example embodiment.

The learning engine 202 manages a learning model for identifying free time of a user. In example embodiments, a user opts in to allow the learning engine 202 to analyze events on a computing system managed calendar of the user to identify trends (e.g., a given time during a day or week when the user typically has meetings or events). The learning engine 202 accesses user information, via the data module 204, from the data storage 206. The user information includes past and current calendar information for the user. Using the past calendar information, the learning engine 202 can identify trends. For example, the learning engine 202 learns, based on blocked out time on the calendar, that the user likes a certain amount of free time each day or on certain days; thus building a learning model. The free time may comprise time the user needs, when not in events, to focus on work or other activities. In one embodiment, the amount of free time for a given day or week is derived from free time indicated on the calendar (e.g., where no events are scheduled).

Based on the learning model, the learning engine 202 can, in one embodiment, suggest to the user an amount of free time to have each day or week. In a further embodiment, the learning engine 202 can proactively reserve free time on the calendar and the user can later adjust the free time. In some cases, the free time reserved by the learning engine 202 may be based on the past calendar information. For example, if the user typically reserves certain times for their free time, the learning engine 202 will attempt to reserve those certain times (e.g., not allow adding an event during those times or suggests other times).

In addition to learning trends regarding amount of free time for the user, the learning engine 202 also identifies trends regarding free time between events. For example, the learning engine 202 may learn that the user likes to have free time or a certain amount of time between events scheduled on their computing system managed calendar. For example, the user may typically want to have a half hour between two meetings in order to prepare for the second meeting. All of the trends identified by the learning engine 202 may be stored, via the data module 204, to the data storage 206 or provided to the time module 208 for further processing.

The data module 204 stores and retrieves the user information to/from the data storage 206. For each user, the user information comprises data regarding events the user has scheduled in their calendar. For example, the user may have accepted an invitation to the event, created the event, or blocked off time for the event. The user information also comprises data regarding events the user has been invited to, but has yet to accept. Further still, the user information comprises user data derived by the learning engine 202 from past events, as discussed above.

In example embodiments, the data storage 206 is configured to store user information for individual users in user specific data stores or databases (hereinafter collectively referred to as a “user data structure”). For instance, each user data structure may correspond to a mailbox and/or computing system managed calendar of the user. While the data storage 206 is shown to be a part of the scheduling system 102, in some embodiments, the data storage 206 may be located elsewhere in the environment 100 and be communicatively coupled to the scheduling system 102. Additionally, any number of data storage 206 may be used to store the user data structures.

The time module 208 manages free time determinations and indications at the scheduling system 102. When a user creates a new event or views an invitation to a new event, the time module 208 accesses, via the data module 204, the user data structure for the user to determine a current amount of free time available for the user for the day. The time module 208 then determines an impact the new event will have on the free time of the user. In some embodiments, the time module 208 will indicate an amount of free time that is being reduced by the new event or acceptance of the new event.

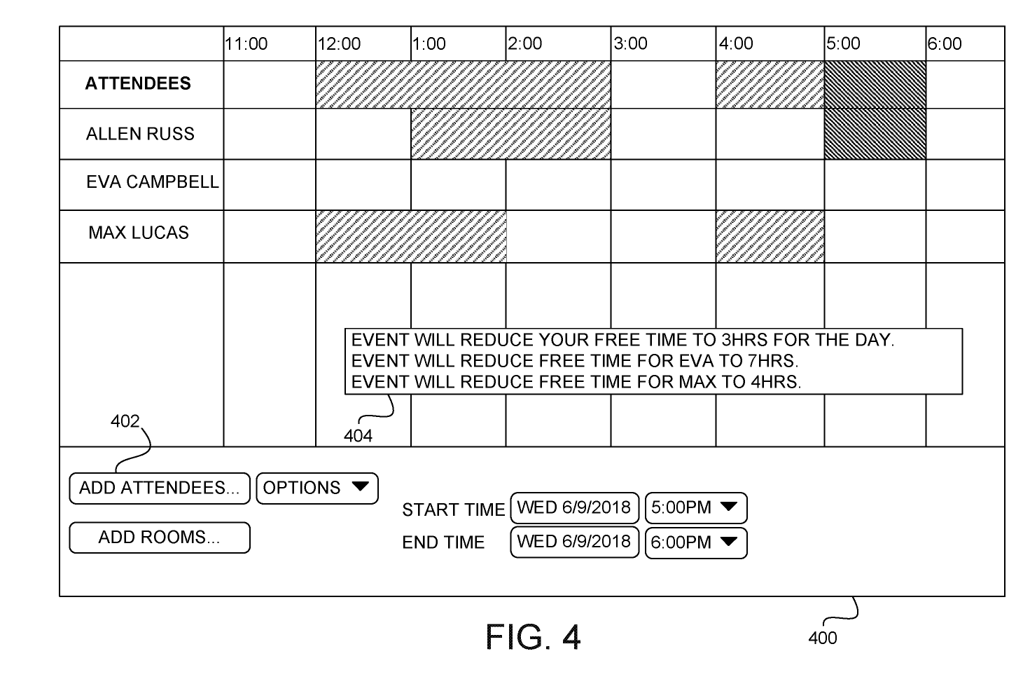

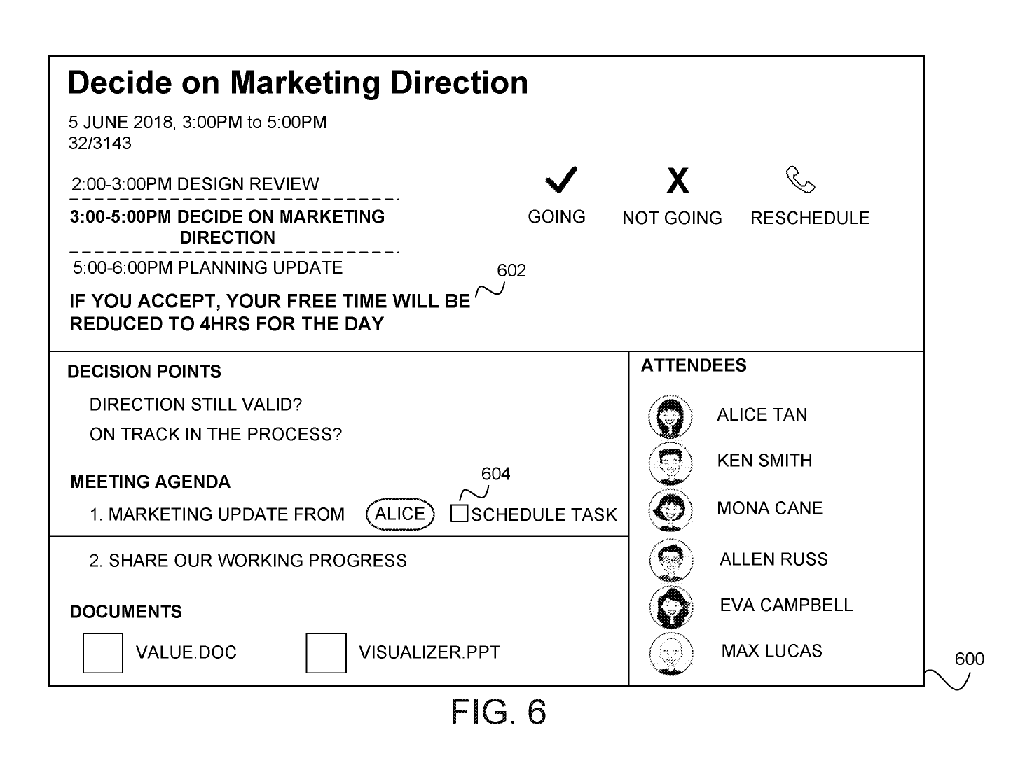

The user interface module 210 is configured to cause presentation of specially configured user interfaces on the client devices (e.g., client devices 106 and 108) that includes a visual indication of the impact on the free time. In example embodiments, the user interface module 210 generates and transmits instructions to the client devices to render and display the user interfaces. In other embodiments, the user interface module 210 generates and presents the user interfaces. In example embodiments, the user interface module 210 generates and presents an event creation user interface, an event invitation user interface, or a calendar user interface. An example of an event creation user interface is presented below in connection with FIG. 4, while an example of an event invitation user interface is presented below in connection with FIG. 6. The calendar user interface may comprise a view of a schedule of the user (e.g., daily schedule, weekly schedule, or monthly schedule) with a visual indication of an amount of free time during the day, week, or month.

The communication module 212 is configured to exchange communications with the client devices (e.g., client devices 106 and 108). For example, the communication module 212 receives a request to create an event and transmits an event creation user interface (or instructions to create the event creation user interface) in response. The communication module 212 may also transmit for display an event invitation user interface to a client device of a user that is invited to an event and receive, in response, an acceptance or rejection of the invitation.

Any one or more of the components (e.g., modules, engines) described herein may be implemented using hardware alone (e.g., one or more processors of a machine) or a combination of hardware and software. For example, any component described herein may physically include an arrangement of one or more of the processors or configure a processor (e.g., among one or more processors of a machine) to perform the operations described herein for that module. Accordingly, different components described herein may include and configure different arrangements of the processors at different points in time or a single arrangement of the processors at different points in time. Each component (e.g., module) described herein is an example of a means for performing the operations described herein for that component. Moreover, any two or more of these components may be combined into a single component, and the functions described herein for a single component may be subdivided among multiple components. Furthermore, according to various example embodiments, components described herein as being implemented within a single machine, database, or device may be distributed across multiple machines, databases, or devices. The scheduling system 102 may comprise other components not pertinent to example embodiments that are not shown or discussed. Further still, one or more of the components of the scheduling system 102 may be located at one or more of the client devices.

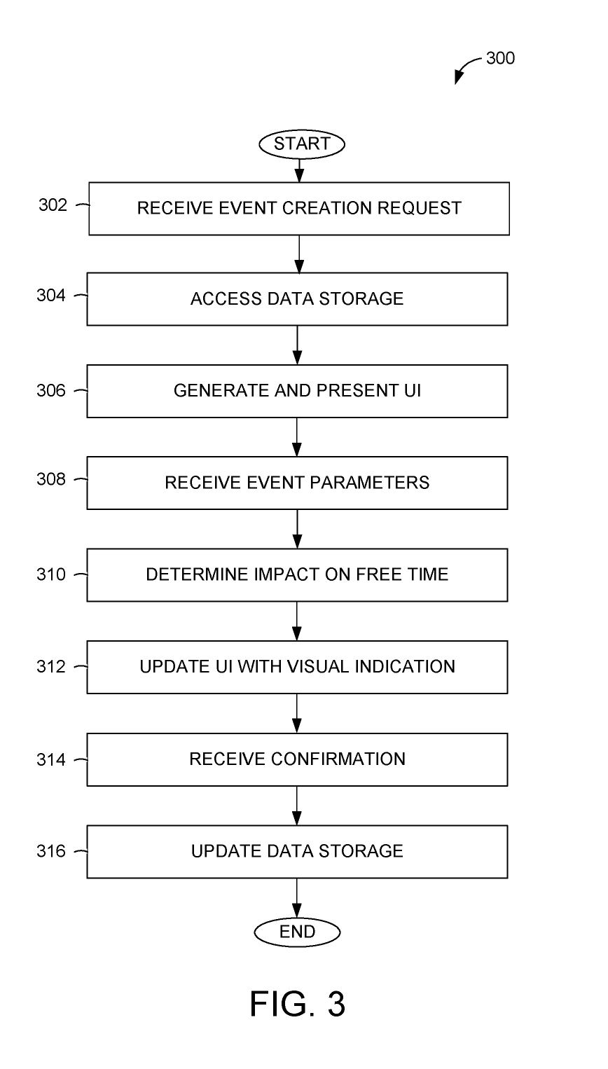

FIG. 3 is a flow diagram of an example method 300 for creating an event invitation that includes visual indications of impact on free time. Operations in the method 300 may be performed by the scheduling system 102, using components (e.g., modules, engines) described above with respect to FIG. 2. Accordingly, the method 300 is described by way of example with reference to the scheduling system 102. However, it shall be appreciated that at least some of the operations of the method 300 may be deployed on various other hardware configurations or be performed by similar components residing elsewhere. For example, some of the operations may be performed at the client device 106 or 108.

In operation 302, the scheduling system 102 receives an event creation request from a user (also referred to as “event organizer”) at a client device (e.g., the client device 106). In example embodiments, the user may access a scheduling application or the scheduling system 102 and indicate a desire to create an event (e.g., a meeting, a conference call). The scheduling system 102 receives the request via the communication module 212.

In response to the request, in operation 304, the data module 204 accesses a user data structure for the user from the data storage 206. The user data structure indicates a current schedule of the user which includes any previously scheduled events and time that may have been set aside for free time.

In operation 306, the user interface module 210 generates and presents (e.g., via the communications module 212) an event creation user interface to the client device. The event creation user interface may include an indication of available time slots in which a new event can be scheduled as well as time blocked off for previously scheduled events. The event creation user interface may also indicate a current amount of free time.

In operation 308, event parameters are received by the user interface module 210 via the communication module 212. The event parameters include a day and time for the new event. In cases where the event involves other individuals, the event parameters include an indication of the other individuals (e.g., user name, e-mail address) who are collectively referred to as the “invitee.”

In operation 310, an impact on the free time for the user and the invitee, based on the event parameters, is determined by the time module 208. In example embodiments, the time module 208 may determine an amount of free time that is being reduced for the day or free time that is being reduced between events (e.g., time is reduced to 1 hour from the 1.5 hours the user typically likes between meeting) if the event is scheduled.

In operation 312, the user interface module 210 updates the event creation user interface with a visual indication of the impact on the free time. In some embodiments, the event creation user interface visually indicates an amount of free time that is being reduced. In other embodiments, the event creation user interface visually indicates a notification that the event is being scheduled during a user's or invitee's normal free time (e.g., a time period of the event conflicts with the free time), for example, as determined by the learning engine 202. The visual indication may comprise other notifications regarding the impact the creation of the event will have on the free time of user and/or the invitee.

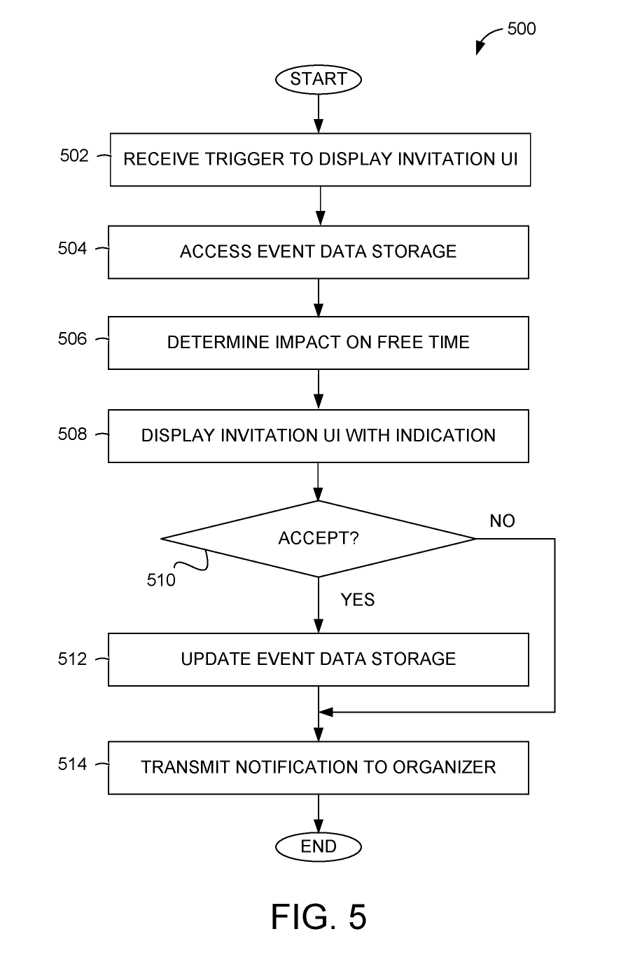

In operation 314, a confirmation of the event creation is received by the communication module 212 from the user. The confirmation triggers the creation of the event on the user's calendar. As a result, in operation 316, the user data structure for the user is updated at the data storage 206 to indicate the new event and, in some cases, the impact on the free time of the user. Additionally, the confirmation triggers creation and transmission of an event invitation user interface to the invitee as will be discussed in more detail in connection with FIG. 5 below.

FIG. 4 illustrates an example event creation user interface 400 that include a visual indication of impact on free time, in accordance with example embodiments. The event creation user interface 400 is rendered and displayed on the client device (e.g., client device 106 or 108) as part of a scheduling assistant (e.g., in a calendar or scheduling application or scheduling system 102). The event creation user interface 400 may be presented, for example, when a user or event organizer attempts to create a new event (e.g., meeting, conference call, task).

In the present example, the event organizer is Allen Russ, and Allen is attempting to create a new event. Allen intends on inviting Eva Campbell and Max Lucas to the event by selecting an “add attendees” selection 402 and including their identifier (e.g., name or email address). When an invitee is added, the scheduling system (e.g., data module 204) accesses the user data structures of each of the invitees to determine their schedules including any blocked time (e.g., shown shaded on the event creation user interface 400) and unblocked time (e.g., free time) on their respective computing system managed calendar. The user interface module 210 causes presentation of the schedules of the event organizer and the invitees on the event creation user interface 400 so that Allen can see when every individual may have time available for the event. In the present example, Allen decides to schedule the new event between the hours of 5:00 and 6:00.

The event parameters of the event being between the hours of 5:00-6:00 causes the time module 208 to determine the impact on the free time of each of the individuals included on the event creation user interface 400. A result of the determination is then visually indicated on the event creation user interface 400 by the user interface module 210. In the present example, a visual indication 404 (e.g., a banner) is displayed indicating that the event will reduce Allen's free time to 3 hours for the day (e.g., based on a 9:00-6:00 work day). Additionally, the visual indication 404 indicates that the event, if accepted by the other invitees, will reduce Eva's free time to 7 hours and reduce Max's free time to 4 hours. In some embodiments, the impact on free time of the invitees is not shown to the event organizer, Max. In other embodiments, the event organizer is only shown the impact on the free time of an invitee only if the invitee grants permission for that information to be shared. The permission setting is stored in the user data structure at the data storage 206. While the visual indication 404 is shown below the calendar information in the example event creation user interface 400, alternative embodiments may place the banner in any location on the event creation user interface 400.

Further still, the visual indication 404 may in addition, or alternatively, indicate other visual notifications of the impact on the free time. For example, the banner 404 may indicate that a period of time selected for the new event (e.g., 5:00-6:00) is during a particular invitee's free time.

FIG. 5 is a flow diagram of an example method 500 for managing a response process to an event invitation. Operations in the method 500 may be performed by the scheduling system 102, using components (e.g., modules, engines) described above with respect to FIG. 2. Accordingly, the method 500 is described by way of example with reference to the scheduling system 102. However, it shall be appreciated that at least some of the operations of the method 500 may be deployed on various other hardware configurations or be performed by similar components residing elsewhere. For example, some of the operations may be performed at the client device 106 or 108.

In operation 502, a trigger to display an event invitation user interface 500 is received by the communication module 212. In example embodiments, the user may receive a notification that the user is invited to an event. For example, the user may receive an e-mail indicating that the user is invited to a meeting or conference call. The user may trigger a display of an event invitation in response via the notification (e.g., a link in the notification) and/or via accessing a scheduling application or the scheduling system 102 and indicate a desire to view the event invitation. The scheduling system 102 receives the request as the trigger via the communication module 212.

In response to the trigger, in operation 504, the data module 204 accesses a user data structure for the invitee from the data storage 206. The user data structure indicates a current schedule of the invitee which includes any previously scheduled events and free time.

In operation 506, the time module determines an impact on the free time of the invitee. In example embodiments, the time module 208 may determine an amount of free time that is being reduced for the day or free time that is being reduced between events (e.g., time is reduced to 1 hour from the 1.5 hours the user typically likes between meeting) for the invitee. The time module 208 may also determine whether the time of the event conflicts with normal free time of the invitee (e.g., based on the learning model).

In operation 508, the user interface module 210 generates the event invitation user interface with a visual indication of the impact on the free time, and causes display of the event invitation user interface on a client device of the invitee (e.g., the client device 108). In some embodiments, the event invitation user interface visually indicates an amount of free time that is being reduced. In other embodiments, the event invitation user interface visually indicates a notification that the event is being scheduled during the invitee's normal free time (e.g., determined by the learning engine 202). The visual indication may comprise other notifications regarding the impact attending the event will have on the free time of the invitee.

In operation 510, a determination is made as to whether the invitee accepts the event invitation. In example embodiments, the communication module 212 receives an indication of acceptance of the event, rejection of the event, or, in some cases, a proposal of a different date or time for the event. The proposal of the different date or time may be treated by the scheduling system 102 as a rejection of the event invitation and a creation of a new event.

If the invitee rejects the event invitation in operation 510, then the communication module 514 generates and transmits a notification to the event organizer indicating that the invitee will not attend the event. However, if the invitee accepts the event invitation in operation 510, then, in operation 512, the user data structure for the invitee is updated at the data storage 206 to indicate the new event in their schedule. Additionally, the acceptance causes transmission of a notification to the organization that the invitee will attend the event in operation 514.

FIG. 6 illustrates an example event invitation user interface 600 that includes a visual indication 602 of impact on the free time of the invitee. The event invitation user interface 600 is rendered and displayed on the client device (e.g., client device 108) as part of a scheduling assistant (e.g., in a calendar or scheduling application or scheduling system 102). The event invitation user interface 600 may be presented, for example, when the invitee selects a link to view an event invitation.

In the present example, the invitee is Alice Tan, and the event invitation is for a meeting between 3:00-5:00 pm (shown bolded in a schedule on the event invitation user interface 600). The visual indication 602 indicates that if Alice accepts the event invitation, her free time will be reduced to 4 hours for the day.

In the present example, the event also includes a meeting agenda that indicates that Alice would provide a marking update. Thus, there is also a selection 604 to schedule a task to prepare the marketing update. The scheduling of the task will reduce Alice's free time even more. If Alice accepts the event, Alice would then schedule the task and define an amount of time required for that task. The time module 208 will reduce the free time more based on the amount of time defined for the task. In some embodiments, the scheduling system may suggest a time (e.g., two days before the event for an hour) and let Alice adjust the time.

FIG. 7 is a block diagram illustrating components of a machine 700, according to some example embodiments, able to read instructions 724 from a machine-storage medium 722 and perform any one or more of the methodologies discussed herein, in whole or in part. Specifically, FIG. 7 shows the machine 700 in the example form of a computer device (e.g., a computer) within which the instructions 724 (e.g., software, a program, an application, an applet, an app, or other executable code) for causing the machine 700 to perform any one or more of the methodologies discussed herein may be executed, in whole or in part.

For example, the instructions 724 may cause the machine 700 to execute the flows and flow diagrams of FIGS. 4 and 5. The instructions 724 can transform the general, non-programmed machine 700 into a particular machine (e.g., specially configured machine) programmed to carry out the described and illustrated functions in the manner described.

In alternative embodiments, the machine 700 operates as a standalone device or may be connected (e.g., networked) to other machines. The machine 700 may be a server computer, a client computer, a personal computer (PC), a tablet computer, a laptop computer, a netbook, a set-top box (e.g. STB), a personal digital assistant (PDA), a cellular telephone, a smartphone, a web appliance, a network router, a network switch, a network bridge, a power adapter, or any machine 700 capable of executing the instructions 724, sequentially or otherwise, that specify actions to be taken by that machine 700. Further, while only a single machine 700 is illustrated, the term “machine” shall also be taken to include a collection of machines that individually or jointly execute the instructions 724 to perform any one or more of the methodologies discussed herein.

The machine 700 includes a processor 702 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 704, and a static memory 706, which are configured to communicate with each other via a bus 708. The processor 702 may contain microcircuits that are configurable, temporarily or permanently, by some or all of the instructions 724 such that the processor 702 is configurable to perform any one or more of the methodologies described herein, in whole or in part. For example, a set of one or more microcircuits of the processor 702 may be configurable to execute one or more modules (e.g., software modules) described herein.

The machine 700 may further include a graphics display 710 (e.g., a plasma display panel (PDP), a light emitting diode (LED) display, a liquid crystal display (LCD), a projector, a cathode ray tube (CRT), or any other display capable of displaying graphics or video). The machine 700 may also include an alphanumeric input device 712 (e.g., a keyboard or keypad), a cursor control device 714 (e.g., a mouse, a touchpad, a trackball, a joystick, a motion sensor, an eye tracking device, or other pointing instrument), a storage unit 716, a signal generation device 718 (e.g., a sound card, an amplifier, a speaker, a headphone jack, or any suitable combination thereof), and a network interface device 720.

The storage unit 716 includes the machine-storage medium 722 on which are stored the instructions 724 embodying any one or more of the methodologies or functions described herein. The instructions 724 may also reside, completely or at least partially, within the main memory 704, within the processor 702 (e.g., within the processor's cache memory), or both, before or during execution thereof by the machine 700. Accordingly, the main memory 704 and the processor 702 may be considered machine-storage media 722 (e.g., tangible and non-transitory machine-readable media).

In some example embodiments, the machine 700 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the modules described herein.

### Executable Instructions And Machine-Storage Medium

The various memories (i.e., 704, 706, and/or memory of the processor(s) 702) and/or storage unit 716 may store one or more sets of instructions and data structures (e.g., software) 724 embodying or utilized by any one or more of the methodologies or functions described herein. These instructions, when executed by processor(s) 702 cause various operations to implement the disclosed embodiments.

As used herein, the terms “machine-storage medium,” “device-storage medium,” “computer-storage medium” (referred to collectively as “machine-storage medium 722”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 722 include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media 722 specifically exclude carrier waves, modulated data signals, and other such media, at least some of which are covered under the term “signal medium” discussed below.

### Signal Medium

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

### Computer Readable Medium

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 724 may further be transmitted or received over a communications network 726 using a transmission medium via the network interface device 720 and utilizing any one of a number of well-known transfer protocols (e.g., HTTP). Examples of communication networks 726 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” or “signal medium” shall be taken to include any intangible medium that is capable of storing, encoding, or carrying instructions 724 for execution by the machine 700, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-storage medium 722 or in a signal medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 702 or a group of processors 702) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

### EXAMPLES

Example 1 is a system for tracking and visually indicating impact of events on free time. The system includes one or more processors and a storage medium storing instructions that, when executed by the one or more hardware processors, causes the one or more hardware processors to perform operations comprising receiving a request associated with an event; accessing, from a data storage, a user data structure for a user associated with the event, the user data structure indicating scheduling information for the user including free time of the user; determining an impact on the free time of the user based on the user attending the event; generating a user interface that includes a visual indication of the impact of attending the event on the free time of the user; and causing presentation of the user interface on a client device of the user.

In example 2, the subject matter of example 1 can optionally include wherein the receiving the request associated with the event comprises receiving a request to create the event from the user; and the generating the user interface that includes the visual indication of the impact of attending the event on the free time of the user comprises generating an event creation user interface.

In example 3, the subject matter of examples 1-2 can optionally include wherein the visual indication further displays the impact of attending the event on the free time of one or more invitees to the event, the user being an event organizer and the one or more invitees being different from the user.

In example 4, the subject matter of examples 1-3 can optionally include wherein the operations further comprise receiving event parameters for the event, wherein the determining the impact on the free time of the user comprises reducing the free time based on the parameters of the event.

In example 5, the subject matter of examples 1-4 can optionally include wherein the receiving the request associated with the event comprises receiving a request to view an event invitation; the user is an invitee of the event; and the generating the user interface that includes the visual indication of the impact of attending the event on the free time of the user comprises generating an event invitation user interface that includes the visual indication of the impact of attending the event on the free time of the invitee.

In example 6, the subject matter of examples 1-5 can optionally include wherein the visual indication of the impact of attending the event comprises an indication in reduction of the free time of the user.

In example 7, the subject matter of examples 1-6 can optionally include wherein the visual indication of the impact of attending the event comprises a notification that a time period of the event conflicts with the free time of the user.

Example 8 is a method for tracking and visually indicating impact of events on free time. The method comprises receiving a request associated with an event; accessing, from a data storage, a user data structure for a user associated with the event, the user data structure indicating scheduling information for the user including free time of the user; determining, by a hardware processor, an impact on the free time of the user based on the user attending the event; generating a user interface that includes a visual indication of the impact of attending the event on the free time of the user; and causing presentation of the user interface on a client device of the user.

In example 9, the subject matter of example 8 can optionally include wherein the receiving the request associated with the event comprises receiving a request to create the event from the user; and the generating the user interface that includes the visual indication of the impact of attending the event on the free time of the user comprises generating an event creation user interface.

In example 10, the subject matter of examples 8-9 can optionally include wherein the visual indication further displays the impact of attending the event on the free time of one or more invitees to the event, the user being an event organizer and the one or more invitees being different from the user.

In example 11, the subject matter of examples 8-10 can optionally include receiving event parameters for the event, wherein the determining the impact on the free time of the user comprises reducing the free time based on the parameters of the event.

In example 12, the subject matter of examples 8-11 can optionally include wherein the receiving the request associated with the event comprises receiving a request to view an event invitation; the user is an invitee of the event; and the generating the user interface that includes the visual indication of the impact of attending the event on the free time of the user comprises generating an event invitation user interface that includes the visual indication of the impact of attending the event on the free time of the invitee.

In example 13, the subject matter of examples 8-12 can optionally include wherein the visual indication of the impact of attending the event comprises an indication in reduction of the free time of the user.

In example 14, the subject matter of examples 8-13 can optionally include wherein the visual indication of the impact of attending the event comprises a notification that a time period of the event conflicts with the free time of the user.

Example 15 is a machine-storage medium for tracking and visually indicating impact of events on free time. The machine-storage medium configures one or more processors to perform operations comprising receiving a request associated with an event; accessing, from a data storage, a user data structure for a user associated with the event, the user data structure indicating scheduling information for the user including free time of the user; determining an impact on the free time of the user based on the user attending the event; generating a user interface that includes a visual indication of the impact of attending the event on the free time of the user; and causing presentation of the user interface on a client device of the user.

In example 16, the subject matter of example 15 can optionally include wherein the receiving the request associated with the event comprises receiving a request to create the event from the user; and the generating the user interface that includes the visual indication of the impact of attending the event on the free time of the user comprises generating an event creation user interface.

In example 17, the subject matter of examples 15-16 can optionally include wherein the visual indication further displays the impact of attending the event on the free time of one or more invitees to the event, the user being an event organizer and the one or more invitees being different from the user.

In example, 18, the subject matter of examples 15-17 can optionally include wherein the operations further comprise receiving event parameters for the event, wherein the determining the impact on the free time of the user comprises reducing the free time based on the parameters of the event.

In example 19, the subject matter of examples 15-18 can optionally include wherein the receiving the request associated with the event comprises receiving a request to view an event invitation; the user is an invitee of the event; and the generating the user interface that includes the visual indication of the impact of attending the event on the free time of the user comprises generating an event invitation user interface that includes the visual indication of the impact of attending the event on the free time of the invitee.

In example 20, the subject matter of examples 15-19 can optionally include wherein the visual indication of the impact of attending the event comprises an indication in reduction of the free time of the user or a notification that a time period of the event conflicts with the free time of the user.

Although an overview of the present subject matter has been described with reference to specific example embodiments, various modifications and changes may be made to these embodiments without departing from the broader scope of embodiments of the present invention. For example, various embodiments or features thereof may be mixed and matched or made optional by a person of ordinary skill in the art. Such embodiments of the present subject matter may be referred to herein, individually or collectively, by the term “invention” merely for convenience and without intending to voluntarily limit the scope of this application to any single invention or present concept if more than one is, in fact, disclosed.

The embodiments illustrated herein are believed to be described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A system comprising:
one or more hardware processors; and
a memory storing instructions that, when executed by the one or more hardware processors, cause the one or more hardware processors to perform operations comprising:
receiving a request associated with an event;
accessing, from a data storage, a user data structure for a user associated with the event, the user data structure indicating scheduling information for the user including free time of the user;
determining an impact on the free time of the user based on the user attending the event;
generating a user interface that includes a visual indication of the impact of attending the event on the free time of the user; and
causing presentation of the user interface on a client device of the user.

2. The system of claim 1, wherein:
the receiving the request associated with the event comprises receiving a request to create the event from the user; and
the generating the user interface that includes the visual indication of the impact of attending the event on the free time of the user comprises generating an event creation user interface.

3. The system of claim 2, wherein the visual indication further displays the impact of attending the event on the free time of one or more invitees to the event, the user being an event organizer and the one or more invitees being different from the user.

4. The system of claim 1, wherein the operations further comprise receiving event parameters for the event, wherein the determining the impact on the free time of the user comprises reducing the free time based on the parameters of the event.

5. The system of claim 1, wherein:
the receiving the request associated with the event comprises receiving a request to view an event invitation;
the user is an invitee of the event; and
the generating the user interface that includes the visual indication of the impact of attending the event on the free time of the user comprises generating an event invitation user interface that includes the visual indication of the impact of attending the event on the free time of the invitee.

6. The system of claim 1, wherein the visual indication of the impact of attending the event comprises an indication in reduction of the free time of the user.

7. The system of claim 1, wherein the visual indication of the impact of attending the event comprises a notification that a time period of the event conflicts with the free time of the user.

8. A method comprising:
receiving a request associated with an event;
accessing, from a data storage, a user data structure for a user associated with the event, the user data structure indicating scheduling information for the user including free time of the user;
determining, by a hardware processor, an impact on the free time of the user based on the user attending the event;
generating a user interface that includes a visual indication of the impact of attending the event on the free time of the user; and
causing presentation of the user interface on a client device of the user.

9. The method of claim 8, wherein:
the receiving the request associated with the event comprises receiving a request to create the event from the user; and
the generating the user interface that includes the visual indication of the impact of attending the event on the free time of the user comprises generating an event creation user interface.

10. The method of claim 9, wherein the visual indication further displays the impact of attending the event on the free time of one or more invitees to the event, the user being an event organizer and the one or more invitees being different from the user.

11. The method of claim 8, further comprising receiving event parameters for the event, wherein the determining the impact on the free time of the user comprises reducing the free time based on the parameters of the event.

12. The method of claim 8, wherein:
the receiving the request associated with the event comprises receiving a request to view an event invitation;
the user is an invitee of the event; and
the generating the user interface that includes the visual indication of the impact of attending the event on the free time of the user comprises generating an event invitation user interface that includes the visual indication of the impact of attending the event on the free time of the invitee.

13. The method of claim 8, wherein the visual indication of the impact of attending the event comprises an indication in reduction of the free time of the user.

14. The method of claim 8, wherein the visual indication of the impact of attending the event comprises a notification that a time period of the event conflicts with the free time of the user.

15. A machine-storage medium storing instructions that, when executed by one or more processors of a machine, cause the one or more processors to perform operations comprising:
receiving a request associated with an event;
accessing, from a data storage, a user data structure for a user associated with the event, the user data structure indicating scheduling information for the user including free time of the user;
determining an impact on the free time of the user based on the user attending the event;
generating a user interface that includes a visual indication of the impact of attending the event on the free time of the user; and
causing presentation of the user interface on a client device of the user.

16. The machine-storage medium of claim 15, wherein:
the receiving the request associated with the event comprises receiving a request to create the event from the user; and
the generating the user interface that includes the visual indication of the impact of attending the event on the free time of the user comprises generating an event creation user interface.

17. The machine-storage medium of claim 16, wherein the visual indication further displays the impact of attending the event on the free time of one or more invitees to the event, the user being an event organizer and the one or more invitees being different from the user.

18. The machine-storage medium of claim 15, wherein the operations further comprise receiving event parameters for the event, wherein the determining the impact on the free time of the user comprises reducing the free time based on the parameters of the event.

19. The machine-storage medium of claim 15, wherein:
the receiving the request associated with the event comprises receiving a request to view an event invitation;
the user is an invitee of the event; and
the generating the user interface that includes the visual indication of the impact of attending the event on the free time of the user comprises generating an event invitation user interface that includes the visual indication of the impact of attending the event on the free time of the invitee.

20. The machine-storage medium of claim 15, wherein the visual indication of the impact of attending the event comprises an indication in reduction of the free time of the user or a notification that a time period of the event conflicts with the free time of the user.
